(19) United States
(12) Patent Application Publication
(10) Pub. No.: US 2003/0001833 A1
(43) Pub. Date: Jan. 2, 2003

(54) Low power display device

(75) Inventor: Iain M. Hunter, Brighton (GB)

Correspondence Address: Michael E. Marion, c/o U.S. Philips Corporation, Intellectual Property Department, 580 White Plains Road, Tarrytown, NY, 10591, US

(73) Assignee: KONINKLIJKE PHILIPS ELECTRONICS N.V.

(21) Appl. No.: 10/155,188

(22) Filed: May 24, 2002

(30) Foreign Application Priority Data
Jun. 21, 2001 (GB) 0115146.3

(51) Int. Cl. G09G 5/00

(52) U.S. Cl. 345/212

(57) ABSTRACT

In known active matrix display devices, the column address conductors are charged using DC power. When each column is discharged, the energy held by the column is dissipated. According to the present invention, an active matrix display device is provided wherein its column driving circuitry comprises an input (48) for receiving AC power, and switching circuitry (80) for selectively connecting each of the column address conductors (52) of the display to the input (48) to charge and discharge the column address conductors using AC power. This enables charge to be recovered by the AC power source (12) from the column address conductors (52), thereby reducing the overall power consumption of the device.

The present invention relates to an active matrix display device, and more particularly such a display device which is configured to consume less power than known devices of a similar size.

It is desirable to minimise the power consumption of portable electronic devices in order to maximise the life of their batteries. EP-A-0834763 describes an active matrix liquid crystal display (AMLCD) which seeks to save power by recovering and reusing energy stored in the common electrode of the device.

An object of the invention is to reduce the power consumed by an active matrix display device.

The present invention provides an active matrix display device comprising an array of picture elements addressed by a set of row address conductors and a set of column address conductors, and column driving circuitry, wherein the column driving circuitry comprises an input for receiving AC power, and switching circuitry for selectively connecting each of the column address conductors to the input to charge and discharge the column address conductors using AC power. In known devices, the charge is lost when columns are discharged. The present arrangement enables the use of an AC power source which recovers charge from the column address conductors, thereby reducing the amount of power required by the display device.

Preferably, the display device includes an LC oscillator circuit comprising inductive means and capacitive means to provide the AC power, the LC oscillator circuit having an input for selective connection to a DC supply and an output connected to the column driving circuitry input.

The device may also comprise a first switching means for selectively connecting the LC oscillator circuit input to a DC supply to replace power lost from the LC oscillator circuit. Preferably, the device includes a second switching means which is operable to break the LC oscillator circuit. This serves to interrupt the oscillation of the circuit to enable the charge in the circuit to be replenished.

In a preferred embodiment, the display device includes means for comparing the voltage of each column address conductor with the voltage at the input of the column driving circuitry, and causing the switching circuitry to connect each column address conductor to the column driving circuitry input when the compared voltages are substantially equal. Switching at this point serves to minimise any power loss due to charge redistribution between the column address conductor and the AC power source.

Furthermore, the device may include means for comparing the voltage of each column address conductor with the voltage to be applied to the next picture element to be charged by the conductor, and causing the switching circuitry to disconnect each conductor from the column driving circuitry input when the respective compared voltages are substantially equal.

Means may be included for correcting the voltage on each column address conductor to the voltage to be applied to the next picture element to be charged by the conductor, to substantially correct voltage variation caused by charge redistribution between a column address conductor and the next picture element.

The invention further provides a method of driving an active matrix device of the invention as described above, the method comprising the steps of supplying AC power to the input of the column driving circuitry, and selectively connecting each of the column address conductors to the input to charge the column address conductors using the AC power.

A prior art configuration and an embodiment of the invention will now be described by way of example and with reference to the accompanying schematic drawings, wherein:

FIG. 1 shows a known circuit for charging and discharging a column electrode of a display;

FIG. 2 shows a circuit for charging and discharging a column electrode according to the invention;

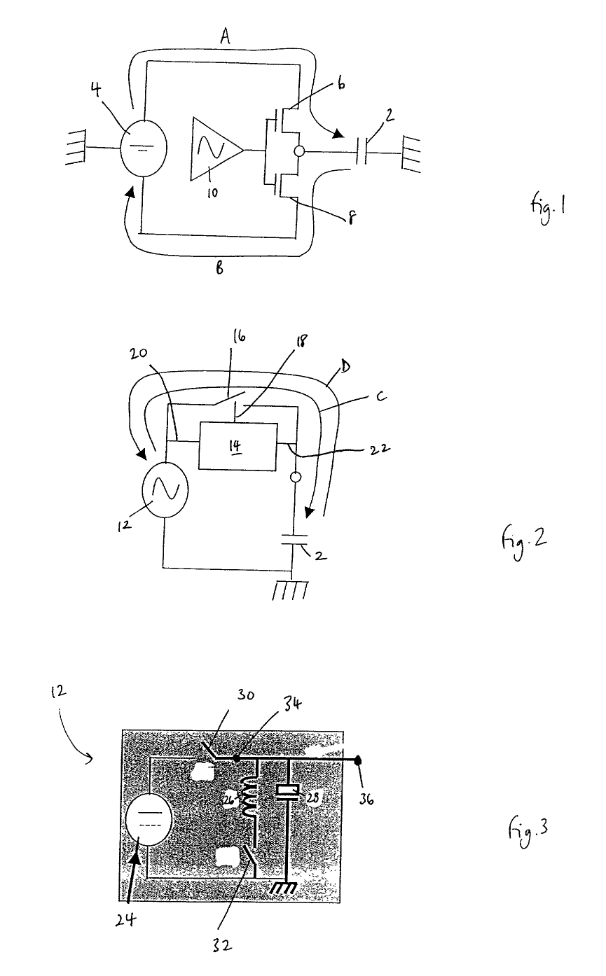

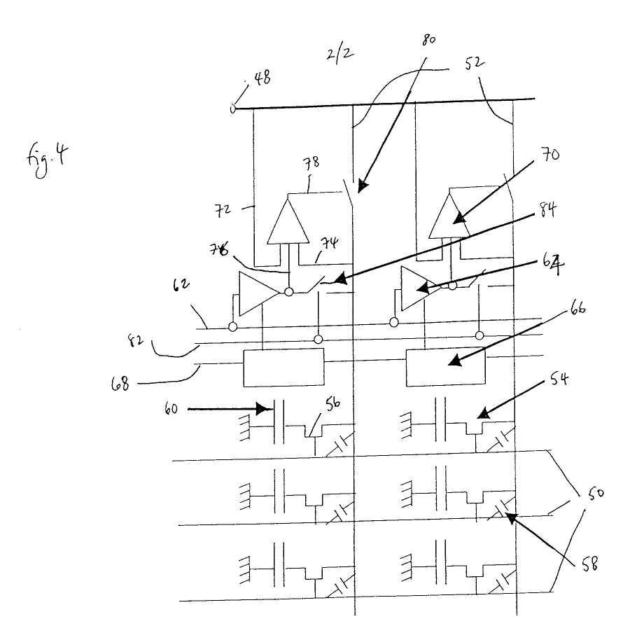

FIG. 3 shows an LC oscillator for use in the circuit of FIG. 2;

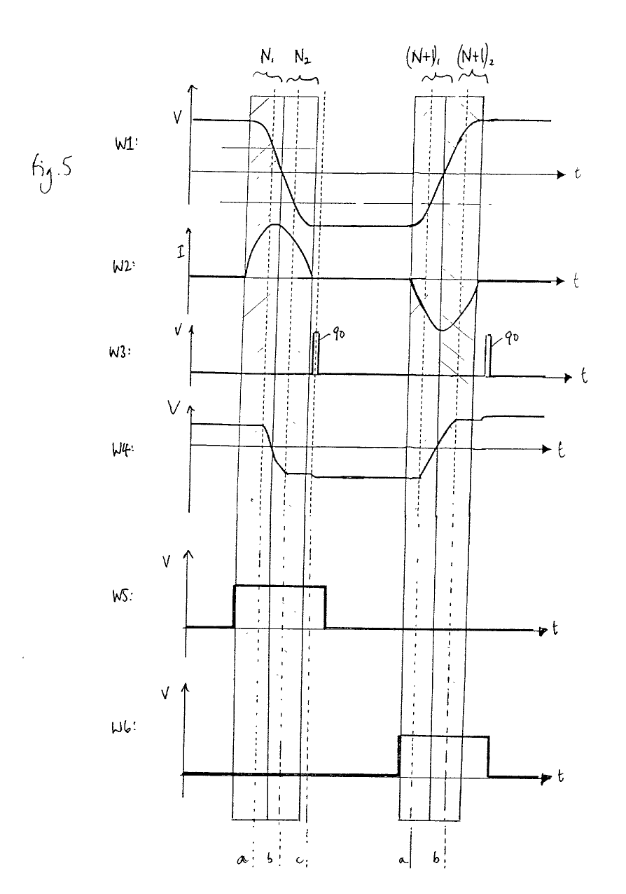

FIG. 4 shows part of an active matrix display and associated column drive circuitry for connection to the LC oscillator of FIG. 3; and

FIG. 5 shows waveforms generated during operation of the circuit shown in FIGS. 2 to 4.

FIG. 1 illustrates how a column electrode is charged in a known portable display device. Only the final output stage of the column driver circuit and the capacitance of a single electrode are shown for clarity. The column capacitance 2 of the electrode is connected to a DC power source 4 via transistors 6 and 8. The transistors 6 and 8 are switched on and off by control circuit 10. The column capacitance is charged to a positive voltage via transistor 6, and is discharged and then charged to a negative voltage via transistor 8. The flow of charge to and from the column capacitance is indicated by arrows A and B, respectively. The charge in this system flows from the DC power source 4 in one direction only, and therefore energy is dissipated by the system.

A circuit for charging a column electrode in accordance with the invention is shown in FIG. 2. The column capacitance 2 of the column electrode is charged and discharged by intermittent connection thereof to an AC power source 12. The connection is controlled so that each column electrode is switched to follow the power source voltage until the voltage desired for the electrode is reached, whereupon the electrode is disconnected from the power source. This process is governed by switching control means 14, which controls a switch 16 via line 18, and monitors the instantaneous power source and column capacitance voltages on lines 20 and 22, respectively. The flow of charge to and from the column capacitance is indicated by arrows C and D, respectively. Switch 16 connects or disconnects the AC power source 12 to or from the column capacitance 2. The switching control means operates the switch in such a way that switching occurs when the voltage across the column capacitance 2 is substantially the same as that across the power source 12 to minimise power loss. This type of operation is sometimes referred to as “zero volt switching”. Charge flowing from the column capacitance is 90° out of phase with the voltage, and so substantially all the charge on the capacitance is returned to the power source. Essentially no power is therefore dissipated, apart from resistive losses. The charging and discharging process is discussed further below.

In a mobile device, the power source is a DC supply provided by a battery. An embodiment of a circuit which converts such a supply into an AC power source 12 capable of recovering energy for use in the configuration of FIG. 2 is shown in FIG. 3. It comprises a DC power source 24, and an LC oscillator circuit formed by an inductor 26 and a capacitor 28 connected in parallel across the DC power source. A switch 30 is connected between the positive terminal of the DC power source and a junction between the capacitor and the inductor for selectively connecting the input 34 of the LC oscillator circuit to the DC power source. A switch 32 is connected between the inductor and the capacitor. The LC oscillator output 36 is connected to the junction between the capacitor and the inductor and provides the AC power source output for connection to the column driving circuitry. Switches 30 and 32 are operated by control means within driving circuitry of the display which are not shown in FIG. 3.

To energise the LC oscillator circuit initially, switch 30 is closed and switch 32 opened. Capacitor 28 is then charged by the DC power supply 24. Oscillation of the circuit can be commenced by opening switch 30 and closing switch 32. The oscillator will oscillate with a resonant frequency fᵣ,

$${f}_{r} = \frac{1}{2 π \sqrt{LC}}$$

where L is the inductance of the inductor 26 and C is the capacitance of the capacitor 28. If the capacitor is fully charged by the DC power supply, the peak to peak voltage of the oscillation will be twice the voltage across the DC power supply.

FIG. 4 schematically shows part of an active matrix liquid crystal display and associated column drive circuitry, having an input 48 for connection to the output 36 of the LC oscillator circuit of FIG. 3. The structure and operation of the active matrix display is conventional and so is not discussed in detail here. Each crossing point of the row and column electrodes of the display, 50 and 52, respectively, has an associated picture element 54. Each picture element comprises a switching element, such as a thin film transistor (TFT) 56 with its gate connected to a respective row electrode 50, its source connected to a respective column electrode 52 and its remaining drain terminal connected to a respective pixel 60. In an AMLCD, the pixel is in the form of a liquid crystal element. A combination of the stray or parasitic capacitance of each TFT 56 and the crossover capacitance of the row and column electrodes at each pixel is represented by a capacitor 58 in each picture element 54, connected between the respective row and column electrodes.

Data defining an image to be displayed is fed to the display drive circuitry along line 62 from signal processing circuitry (not shown), one column at a time. The data for the columns is transferred onto a set of storage devices, one for each column electrode, in the form of sample and hold devices 64, by respective shift register elements 66. The operation of the shift register elements is controlled by a shift input signal fed from the signal processing circuitry along line 68.

A comparing means, in the form of a comparator 70, is associated with each column electrode 52. It has three inputs 72, 74, 76 connected to the drive circuitry input 48 to monitor the LC oscillator output voltage, the corresponding column electrode 52, and the output of the corresponding sample and hold device 64, respectively. The comparator's output 78 controls a switch 80, the switch being operable to connect selectively the associated column electrode 52 to the drive circuitry input 48. A correction signal is fed along line 82, which is connected to control a set of correction switches, 84, one for each column electrode. Each correction switch is connected between the output of the respective sample and hold device 64 and the corresponding column electrode 52.

The operation of the circuitry shown in FIGS. 3 and 4 will now be described having regard to the exemplary waveforms shown in FIG. 5. W1 represents the voltage on the capacitor 28, W2 the current flowing in inductor 26, W3 the correction signal applied to line 82, and W4 the voltage on a particular column electrode 52. W5 and W6 are the voltages on the Nth and (N+1)th row electrodes of the matrix.

As with a conventional row addressing scheme, the row are addressed one at a time. The waveforms of FIG. 5 are shown over two row addressing periods, that is, for two consecutive rows. A half cycle oscillation of the LC oscillator is used for each row in turn. Initially, the image information for a single row is shifted onto the sample and hold devices 64, using the shift registers 66. During this period, the switches 80 are open to isolate the respective column electrodes 52 from the AC power source 12. The power source is in a holding state at this point, with switch 30 closed and switch 32 open, so that capacitor 28 is charged by the DC power source 24.

The charging process will now be discussed in relation to the particular column electrode for which the corresponding waveform, W4, is shown in FIG. 5. The process is considered for consecutive rows, N and N+1. It will be appreciated that a similar procedure will occur for each column of the display.

The LC oscillator is switched into an oscillation mode by opening switch 30 and closing switch 32. At this time, an addressing pulse is applied to the row electrode for row N of the display, turning on the associated row of TFTs 56. This causes the voltages on each of the column electrodes to be applied to the respective LC elements 60 in row N. The capacitor 28 begins to discharge through the inductor 26. The comparator 70 monitors the voltage on the capacitor 28 and the column capacitance via lines 72 and 74, respectively. When the two voltages are substantially identical, the comparator closes switch 80 to connect the column electrode 52 to the AC power source 12 (point a in FIG. 5). Switching should occur at this point, otherwise charge redistribution between the column electrode 52 and the capacitor 28 would result in a significant loss of power. In other words, switching takes place when the power supply reaches the voltage at which the column was disconnected during the addressing of row N−1. The column capacitance then discharges in parallel with the capacitor 28 into the inductor 26 until all the energy they stored is transferred to the inductor's magnetic field. The period during which the capacitor is discharging up to this point is identified as N₁ in FIG. 5.

At this stage, the inductor 26 continues to drive a current. The capacitor 28 and the column electrode therefore charge to the opposite voltage during period N₂ to that of N₁. The comparator 70 continues to monitor the column voltage and compares it to the image data stored on the sample and hold device 64. When these values are substantially the same, the column electrode 52 is isolated by the comparator causing switch 80 to open. This occurs at point b in FIG. 5. Energy transfer from the inductor 26 to the capacitor 28 continues until all the energy is stored on the capacitor at the end of period N₂. At this point, the oscillation of the LC circuit is stopped by opening the switch 32.

Some energy will be lost due to charge redistribution as the LC element capacitance is switched into parallel with the column capacitance. The switch 84 is closed at this stage (point c in FIG. 5) by the application of a correction pulse 90 (see waveform W3) on line 82. This causes the sample and hold device 64 to drive the column electrode in order to correct for any drop in the voltage thereon caused by this charge redistribution.

As noted above, some charge may be lost from the LC oscillator circuit, due to resistive losses for example. The oscillator circuit may therefore be restarted periodically. Its oscillation can be stopped by opening switch 32 (FIG. 3) and the capacitor can then be charged and replenished from the DC power source 24 by closing switch 30. Switch 32 is preferably opened when all the system energy is stored by the capacitor 28, that is, when the current through the inductor 26 is zero, to avoid harmful voltage spikes caused by the rapid collapse in the magnetic field associated with the current carrying inductor when it is uncoupled from the capacitor.

The charging process is repeated for each picture element in the next row of the display, row N+1, charging it to the opposite polarity, as shown in FIG. 5. It can be seen that a row inversion scheme can be implemented, with a swing in the polarity of the voltage across the capacitor 28 charging one row one way, and then the subsequent reverse swing of the capacitor voltage charging the following row the other way. Thus, the majority of the energy lost from the LC oscillator is replaced during a two row cycle. Alternatively, a pixel inversion scheme could be adopted by charging alternate LC elements on the same row with one swing and the other elements on the reverse swing, or by using two LC oscillators to charge alternate LC elements.

Whilst the invention is described above in relation to an AMLCD, it will be appreciated that the invention may be employed in other types of active matrix display device, such as plasma display devices and organic light emitting diode display devices.

From reading the present disclosure, other variations and modifications will be apparent to persons skilled in the art. Such variations and modifications may involve equivalent and other features which are already known in the design, manufacture and use of active matrix display devices, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any Claim and whether or not it mitigates any or all of the same technical problems as does the present invention. Features which are described in the context of separate embodiments may also be provided in combination in a single embodiment. Conversely, various features which are, for brevity, described in the context of a single embodiment, may also be provided separately or in any suitable subcombination. The Applicants hereby give notice that new may be Claims formulated to such features and/or combinations of such features during the prosecution of the present Application or of any further Application derived therefrom.

1. An active matrix display device comprising an array of picture elements addressed by a set of row address conductors and a set of column address conductors, and column driving circuitry, wherein the column driving circuitry comprises an input for receiving AC power, and switching circuitry for selectively connecting each of the column address conductors to the input to charge and discharge the column address conductors using AC power.

2. A device of claim 1 including an LC oscillator circuit comprising inductive means and capacitive means, the LC oscillator circuit having an input for selective connection to a DC supply and an output connected to the column driving circuitry input.

3. A device of claim 2 including a first switching means for selectively connecting the LC oscillator circuit input to a DC supply to replace power lost from the LC oscillator circuit.

4. A device of claim 2 or claim 3 including a second switching means which is operable to break the LC oscillator circuit.

5. A device of any preceding Claim including means for comparing the voltage of each column address conductor with the voltage at the input of the column driving circuitry, and causing the switching circuitry to connect each column address conductor to the column driving circuitry input when the compared voltages are substantially equal.

6. A device of any preceding Claim including means for comparing the voltage of each column address conductor with the voltage to be applied to the next picture element to be charged by the conductor, and causing the switching circuitry to disconnect each conductor from the column driving circuitry input when the respective compared voltages are substantially equal.

7. A device of any preceding Claim including means for correcting the voltage on each column address conductor to the voltage to be applied to the next picture element to be charged by the conductor, to substantially correct voltage variation caused by charge redistribution between a column address conductor and the next picture element.

8. A method of driving an active matrix device of any preceding Claim comprising the steps of supplying AC power to the input of the column driving circuitry, and selectively connecting each of the column address conductors to the input to charge the column address conductors using the AC power.
